(19) United States
(12) Patent Application Publication
(10) Pub. No.: US 2011/0262157 A1
(43) Pub. Date: Oct. 27, 2011

(54) IMAGE FORMING APPARATUS AND IMAGE STABILIZATION CONTROL METHOD IN IMAGE FORMING APPARATUS

(75) Inventor: Norikazu Ochiai, Shizuoka (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/048,188

(22) Filed: Mar. 15, 2011

Related U.S. Application Data
(60) Provisional application No. 61/326,323, filed on Apr. 21, 2010.

(51) Int. Cl. G03G 15/00; G03G 15/06

(52) U.S. Cl. 399/43; 399/55; 399/44; 399/49

(57) ABSTRACT

According to one embodiment of the present invention, an image forming apparatus includes: an image formation unit; an image formation frequency count unit; a first control unit; a target contrast potential determination unit, and a second control unit. The image formation unit forms an image pertaining to a print job input from an external on an image carrier. The image formation frequency count unit counts an image formation frequency of the image in the image formation unit. The first control unit controls the image formation unit, and executes a first image stabilization mode for adjusting a development bias voltage on the basis of a concentration of a pattern image formed on the image carrier. The target contrast potential determination unit determines a target contrast potential which is a target value of a potential difference between a potential of the image carrier after exposed and a potential of a developing device, when the print job is a continuous print job of the same image according to the image formation frequency counted in the continuous print job. The second control unit executes a second image stabilization mode for adjusting a development bias on the basis of the target contrast potential under execution of the continuous print job with the develop bias at the time of completing the first image stabilization mode executed by the first control unit as a reference value.

### CROSS-REFERENCE TO RELATED APPLICATIONS

This application is based upon and claims the benefit of priority from Provisional U.S. Application No. 61/326,323, filed on 21 Apr. 2010, the entire contents of which are incorporated herein by reference.

### FIELD

Embodiments described herein relate generally to an image forming apparatus and an image stabilization control method in the image forming apparatus.

### BACKGROUND

In recent years, a demand for a higher image quality in image forming apparatuses is growing. Also, color image forming apparatuses are increasingly popularized. The color image forming apparatus superimposes toner of four colors consisting of Y (yellow), M (magenta), C (cyan), and K (black) on an object to be transferred in order to express an image of full colors on the object to be transferred. Even if gradation is slightly shifted among the respective colors of toner, the quality of a final image is changed. It is important to always keep a constant gradation against a variation with time and a change in environment of the image forming apparatus. Under the circumstance, a variety of image stabilization control methods are studied in order to keep the gradation.

In general, in the image stabilization control, a test toner mark (pattern image) called “toner patch” is formed on an intermediate transfer belt that is an image carrier, or a sheet, and an image concentration thereof is detected by an optical sensor (toner adhesion amount sensor). Then, an intensity or output timing of a drive signal to LEDs configuring a development bias or an exposing device is adjusted on the basis of a detection signal from the optical sensor to adjust an image forming condition so that the concentration of a toner image of each color becomes proper. The image stabilization control is conducted at a time when a power supply of the image forming apparatus turns on, or a cover is closed or opened.

However, in the conventional image forming apparatus, in the case of a job for sequentially printing a large amount of identical images, a charged amount of toner is reduced with time. This suffers from such a problem that a difference occurs in the image concentration between a printed image on a first sheet and a printed image immediately before the job is completed.

### BRIEF DESCRIPTION OF THE DRAWINGS

FIG. 1 is a perspective view illustrating an external appearance of an image forming apparatus according to a first embodiment;

FIG. 2 is a schematic front view illustrating an internal structure;

FIG. 3 is a block diagram illustrating a control system;

FIG. 4 is a correlation diagram of the control system and an internal device;

FIGS. 5A to 5C are diagrams showing data examples stored in a database unit;

FIG. 6 is a flowchart showing a specific example of a control;

FIG. 7 is a flowchart showing a processing example of a first image stabilization mode shown in Act 604 of FIG. 6;

FIG. 8 is a diagram illustrating an example of a gradation pattern formed on an intermediate transfer belt; and

FIG. 9 is a flowchart showing a processing example of a second image stabilization mode shown in Act 611 of FIG. 6.

### DETAILED DESCRIPTION

According to one embodiment, an image forming apparatus includes: an image formation unit; an image formation frequency count unit; a first control unit; a target contrast potential determination unit, and a second control unit.

The image formation unit forms an image pertaining to a print job input from an external on an image carrier. The image formation frequency count unit counts an image formation frequency of the image in the image formation unit. The first control unit controls the image formation unit, and executes a first image stabilization mode for adjusting a development bias voltage on the basis of a concentration of a pattern image formed on the image carrier.

The target contrast potential determination unit determines, when the print job is a continuous print job of the same image, a target contrast potential which is a target value of a potential difference between a potential of the image carrier after exposed and a potential of the developing device, according to the image formation frequency counted in the continuous print job.

The second control unit executes a second image stabilization mode for adjusting a development bias on the basis of the target contrast potential under execution of the continuous print job with the develop bias at the time of completing the first image stabilization mode which is executed by the first control unit as a reference value.

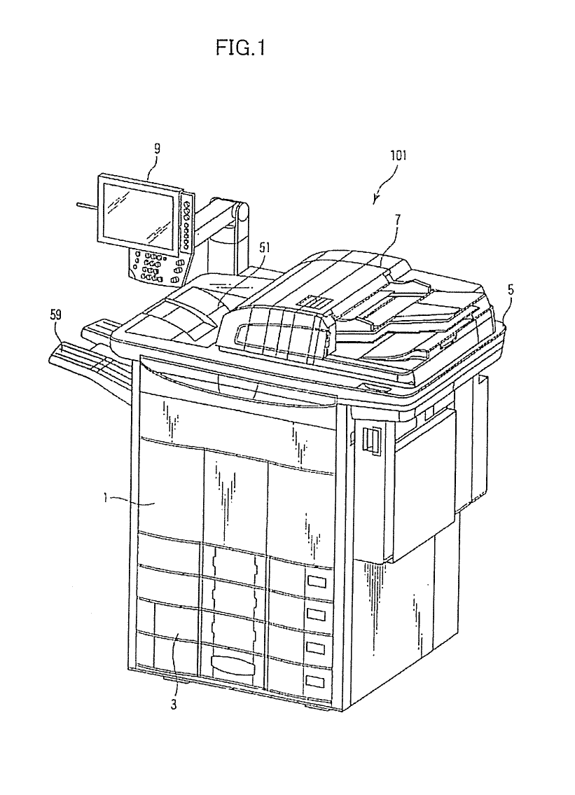

FIG. 1 is a perspective view illustrating an external appearance of an image forming apparatus 101 according to a first embodiment. The image forming apparatus 101 is directed to a color copying machine of a four-drum tandem system. The image forming apparatus 101 includes an image formation unit 1 that outputs image information as an output image that is called, for example, “hard copy” or “print out”; a sheet feed unit 3 that feeds a sheet (output medium) of an arbitrary size used for an image output to the image formation unit 1; and a scanner (image reader) 5 that retrieves image information that is a target of image formation in the image formation unit 1 from an object (hereinafter referred to as “original document”) as image data. An automatic document feeder 7 is disposed above the image formation unit 1. If the original document is a sheet, after the image reader 5 reads the image information, the automatic document feeder 7 discharges the original document, from which the image information is read out, from a read position to an exit position, and guides a subsequent original document to the read position. Also, the image forming apparatus 101 is equipped with an instruction input unit for instructing a start of image formation in the image formation unit 1, or a start for reading the image information of the original document by the image reader 5, that is, a display unit 9 that is a control panel.

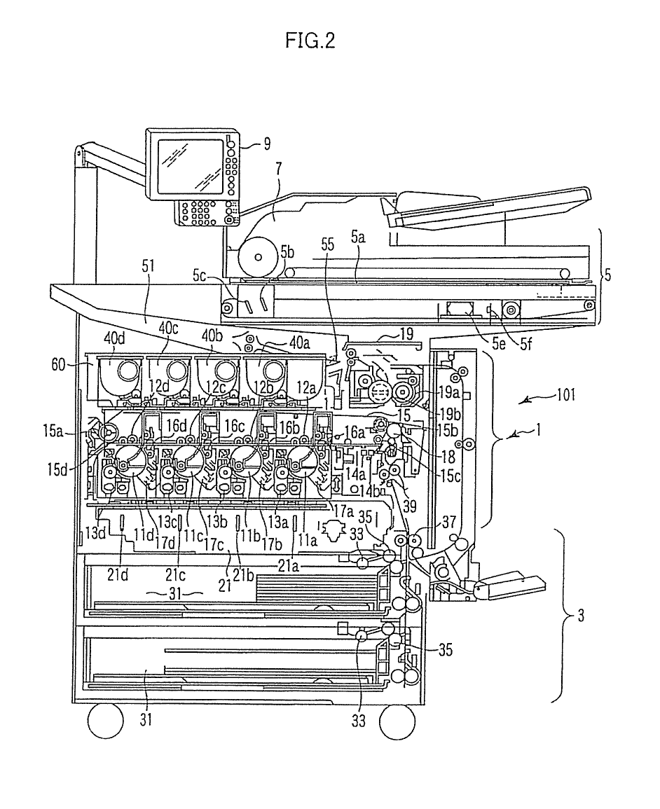

FIG. 2 is a schematic front view illustrating an internal structure of the image forming apparatus 101. First, a structure of the image reader 5 will be described. The image reader 5 includes a platen glass 5a which is transparent and on which the original document is placed, a light source 5b that illuminates the original document and a reflective mirror 5c that reflects a light reflected from the original document. Also, the light source 5b and the reflective mirror 5c are provided integrally with a document illumination unit 5d that is movable in a horizontal direction. The reflected light from the document illumination unit 5d is received through an imaging lens 5e arranged on an optical path.

Subsequently, a configuration of the image formation unit 1 will be described. Toner cartridges 40a, 40b, 40c, and 40d are disposed in parallel on an upper side of the image formation unit 1. The toner cartridges 40a, 40b, 40c, and 40d are detachably attached to a cartridge holding mechanism 60 disposed on a front side of the image formation unit 1. The toner cartridges 40a, 40b, 40c, and 40d supply toner of yellow (Y), magenta (M), cyan (C), and black (K). Also, the toner sensors 70a, 70b, 70c, and 70d not shown are disposed in the vicinity of the toner cartridges 40a, 40b, 40c, and 40d, respectively, so as to detect the remaining amount of toner of corresponding colors.

The image formation unit 1 includes first to fourth photosensitive drums 11a to 11d as image carriers that each hold a latent image; developing devices 13a to 13d that develop the latent images formed on the photosensitive drums 11a to 11d, respectively; an intermediate transfer belt 15 holds images developed on the photosensitive drums 11a to 11d with developer in a stacked state, cleaners 16a to 16d that remove toner remaining on the photosensitive drums 11a to 11d from the photosensitive drums 11a to 11d, respectively; and static chargers 17a to 17d that uniformly charge the photosensitive drums 11a to 11d.

The image formation unit 1 includes a transfer device 18 that transfers the images of developer stacked on the intermediate transfer belt 15 onto a sheet-like output medium such as a general plain paper that is not subjected to specific processing, or an OHP sheet that is a transparent resin sheet, and a fixing device 19 that fixes the image of developer transferred onto an object to be transferred to an output medium. Also, the image formation unit 1 includes an exposing unit 21 made up of LEDs 21a to 21d that irradiate the photosensitive drums 11a to 11d with laser beams modulated according to write image data to form latent images, respectively.

The intermediate transfer belt 15 is extended by a driving roll 15a for rotating the intermediate transfer belt 15, a tension roll 15b for keeping a constant tension applied to the intermediate transfer belt 15, and a backup roll 15c for secondary transfer.

Primary transfer rolls 12a to 12d are arranged on a rear side of the intermediate transfer belt 15 so as to come in press contact with the photosensitive drums 11a to 11d through the intermediate transfer belt 15 at portions (primary transfer unit) where the intermediate transfer belt 15 is abutted against the photosensitive drums 11a to 11d, respectively.

The transfer device 18 is abutted against the intermediate transfer belt 15 on a tone carrier surface side (outside) of the intermediate transfer belt 15 (secondary transfer unit), and faces the backup roll 15c disposed on the rear side (inside) of the intermediate transfer belt 15.

Also, a belt cleaner 15d is abutted against the intermediate transfer belt 15 at a portion of the intermediate transfer belt 15 where the driving roll 15a is disposed, so as to face the driving roll 15a through the intermediate transfer belt 15.

Also, an LED light source 14a and an optical sensor 14b for detecting the amount of reflected light from a toner pattern formed on the intermediate transfer belt 15 are arranged between a fourth station of the primary transfer unit and the secondary transfer unit.

The first to fourth photosensitive drums 11a to 11d hold electrostatic images (latent images) of colors to be visualized (developed) by the developing devices 13a to 13d that each contain an arbitrary color of yellow (Y), magenta (M), cyan (c), and black (K). The order of the arrangement of the photosensitive drums 11a to 11d is defined in a given order according to the characteristics of an image forming process or toner (developer). The intermediate transfer belt 15 holds the developer images of the respective colors formed by the first to fourth photosensitive drums 11a to 11d and the corresponding developing devices 13a to 13d in the formation order.

The sheet feed unit 3 feeds the output medium to the transfer device 18 at a given timing when the transfer device 18 transfers the image of developer.

Cassettes set in a plurality of cassette slots 31 each contain output media of an arbitrary size. A pickup roller 33 picks up the output medium according to the image formation operation. The size of the output media corresponds to a size of the image of developer formed by the image formation unit 1. A separation mechanism 35 prevents the number of output media extracted from each cassette by the pickup roller 33 from becoming two or more. A plurality of transport rollers 37 transport one output medium limited by the separation mechanism 35 toward an aligning roller 39. The aligning roller 39 sends the output medium to a transfer position where the transfer device 18 and the intermediate transfer belt 15 contact each other at timing when the transfer device 18 transfers the image of developer from the intermediate transfer belt 15. The cassette slots 31, the pickup roller 33, and the separation mechanism 35 are prepared in plurality as occasion demands, and the cassettes can be arbitrarily loaded in a different slot.

The output medium to which the image information is fixed through the fixing device 19 is discharged into a sheet exit tray 51 that is located at a side of the image reader 5 and above the image formation unit 1. In this example, the fixing device 19 has a fixing roller 19a and a pressure roller 19b at a downstream side along a sheet exit direction. The image of developer transferred onto the output medium is melted by the fixing roller 19a heated up to 180° C. and the pressure roller 19b to fix the image information.

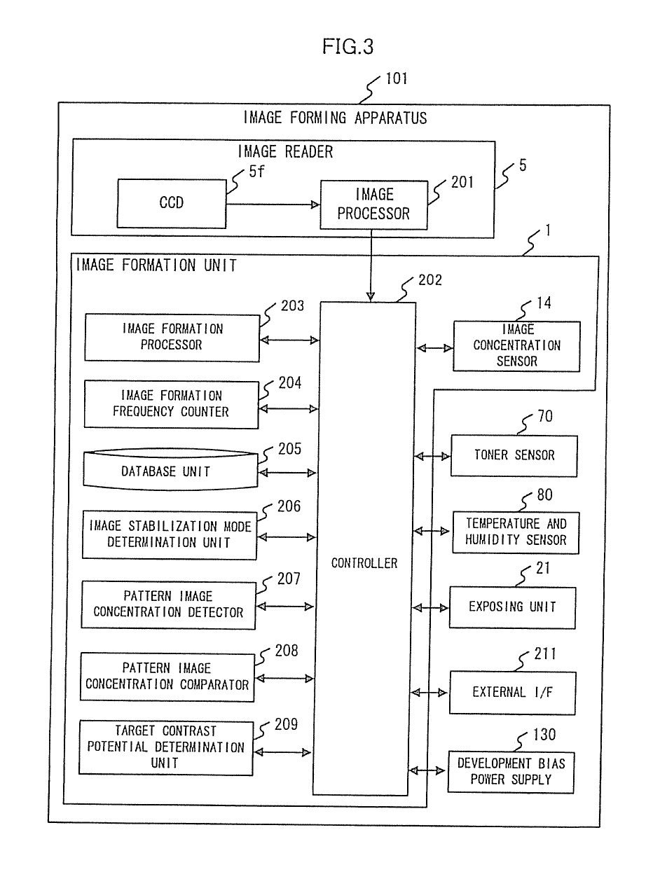

FIG. 3 is a block diagram illustrating a control system of the image forming apparatus 101 according to this embodiment. The image reader 5 side is provided with an image processor 201. The image processor 201 converts an output signal from the reflected light received by a CCD 5f into image data of yellow (Y), magenta (M), cyan (c), and black (K), subjects the image data to data processing such as concentration correction, and output the processed data as write image data.

Also, the image formation unit 1 includes a controller 202, an image formation processor 203, an image formation frequency counter 204, a database unit 205, an image stabilization mode determination unit 206, a pattern image concentration detector 207, a pattern image concentration comparator 208, and a target contrast potential determination unit 209.

The controller 202 controls the LEDs 21a to 21d of the exposing unit 21 according to the write image data (hereinafter referred to as “print image data”) created by the above image processor 201, or print image data acquired through an external interface 211. Then, the controller 202 irradiates the photosensitive drums 11a to 11d with the modulated laser beam.

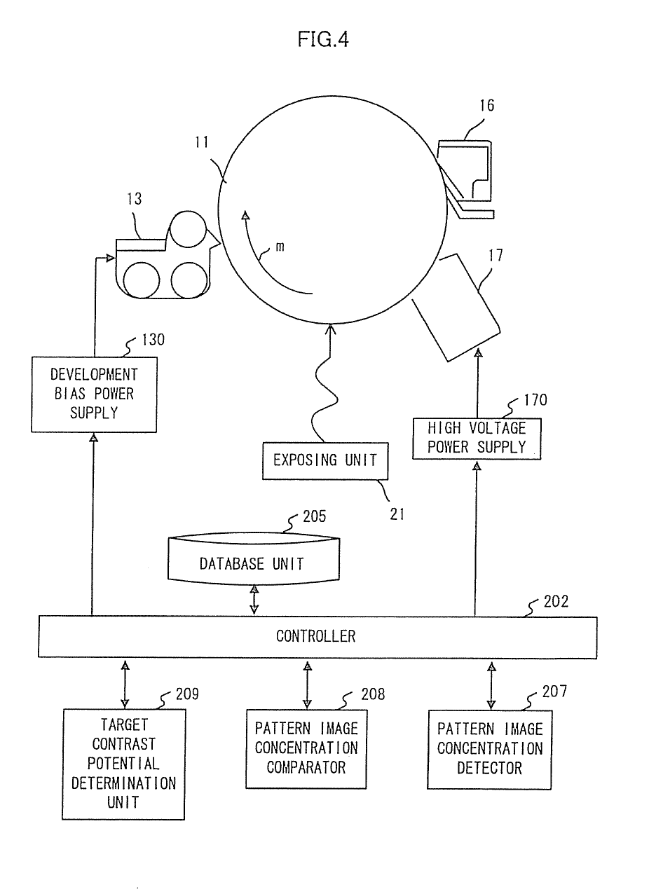

Also, the controller 202 forms a pattern image on the basis of a determination result by the image stabilization mode determination unit 206 that will be described later, and conducts an image stabilization control (hereinafter referred to as “first image stabilization mode”) that adjusts the development bias voltage, or an image stabilization control (hereinafter referred to as “second image stabilization mode”) that adjusts a contrast potential, on the basis of an image concentration of the pattern image. FIG. 4 is a correlation diagram of the control system and an internal device of the image forming apparatus illustrated in FIG. 1.

If the controller 202 conducts the control in the first image stabilization mode (pattern image concentration adjustment), the controller 202 repetitively forms the pattern image on the intermediate transfer belt 15 by the image formation processor 203 and the exposing unit 21 while adjusting the pattern image concentration until a comparison result in the pattern image concentration comparator 208 that will be described later is matched. The controller 202 executes the control in the first image stabilization mode, for example, when the number of image formation arrives at a given threshold value, immediately after a power supply of the image forming apparatus 101 turns on, or when the image stabilization mode determination unit 206 determines that readjustment of the gradation characteristic is required according to a predetermined condition after a given time elapses.

On the contrary, if the controller 202 conducts the control in the second image stabilization mode (contrast potential adjustment), the controller 202 adjusts the development bias to a given target contrast potential that will be described later.

The image formation processor 203 is a program that includes a print image formation unit 203a and a pattern image formation unit 203b, forms image data (print image data or pattern image data) of developer, which is transferred onto the intermediate transfer belt 15, and outputs the image data to the exposing unit 21.

The image formation frequency counter 204 is a program that counts an image formation frequency of the print image data formed by the pattern image formation unit 203b and records the image formation frequency into the database unit 205.

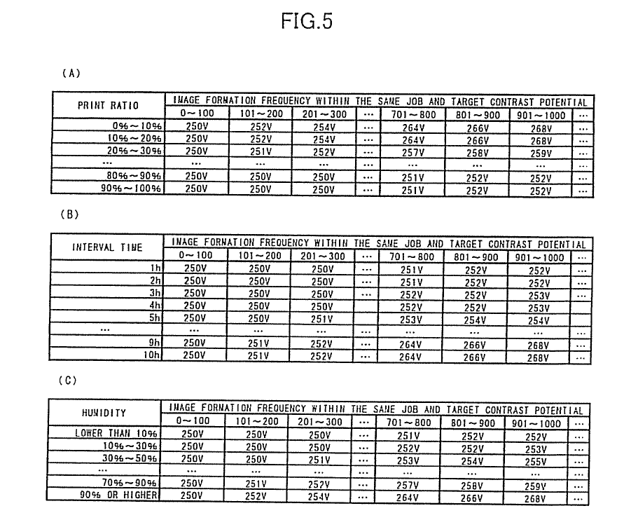

The database unit 205 includes a first Vc adjustment table 205a, a second Vc adjustment table 205b, a third Vc adjustment table 205c, and a print job execution history table 205d (not shown). FIGS. 5A to 5C are diagrams showing data examples stored in the respective tables in the database unit illustrated in FIG. 1.

The first Vc adjustment table 205a is a table storing a relationship between image formation frequency within the same continuous print job, the target contrast potential in the second image stabilization mode, and the print ratio of the print image (FIG. 5A).

The second Vc adjustment table 205b is a table storing a relationship between image formation frequency within the continuous print job, the target contrast potential in the second image stabilization mode, and an interval time from the completion of execution of another print job (FIG. 5B).

The third Vc adjustment table 205c is a table storing a relationship between image formation frequency within the continuous print job, the target contrast potential in the second image stabilization mode, and a humidity within the apparatus (FIG. 5C).

Also, the first Vc adjustment table 205a, the second Vc adjustment table 205b, and the third Vc adjustment table 205c are so defined as to gradually increase the target contrast potential toward an increase in the image formation frequency. For that reason, the development bias is changed on the basis of the target contrast potential, which can cope with a problem that the charged amount of toner is reduced with time.

The first Vc adjustment table 205a, the second Vc adjustment table 205b, and the third Vc adjustment table 205c define the target contrast potential according to a change in the image formation frequency with a difference between the potential of the developing device and the potential of the photosensitive drum 11 after exposing, at the time of completing the execution of the first image stabilization mode, as a reference value. In FIGS. 5A to 5C, the reference value of the contrast potential is defined as 250 V, but only the difference from the reference value may be defined.

Also, the same image is directed to an image within one group to be subjected to the print job, and includes not only a single image but also a plurality of images. For example, if the contents of the continuous print job are 1000 prints of an image file having three pages, an image for three pages is treated as one unit. Accordingly, it is preferable that the target contrast potential and a Vc changeover point which are determined from each table are adjusted according to the number of pages in one image file.

The print job execution history table 205d not shown is a table that stores the execution history (execution user, execution time, print frequency) of the print job therein.

Also, the database unit 205 stores, in addition to the above tables, a data table that stores the image formation frequency in the image formation processor 203 therein, and a management master that records an upper limit of the image formation frequency that is an execution determination reference of the first image stabilization mode therein. Accordingly, if the first image stabilization mode is intended to be periodically conducted, it is preferable that a given threshold value (the upper limit of the image formation frequency) within the management master is set to, for example, 500 times or 1000 times.

The image stabilization mode determination unit 206 is a program that analyzes the print job input from the external. If the input print job is other than the continuous print job of the same image, the program determines that the execution mode is the first image stabilization mode that adjusts the concentration of the pattern image formed on the intermediate transfer belt 15 on the basis of the image formation frequency counted by the image formation frequency counter 204.

Also, if the input job is the continuous print job of the same image as a result of analyzing the job, the image stabilization mode determination unit 206 determines that the second image stabilization mode that adjusts the contrast potential which is a difference between the potential of the developing device 13 and the potential of the photosensitive drums 11a to 11d after exposed is the execution mode. In this embodiment, the image formation condition at the time of completing the first image stabilization mode which is executed last time is used as an initial value of the image formation at the time of executing the second image stabilization mode. During execution of the second image stabilization mode, the conditions (exposure intensity or the charge bias value) other than the development bias value are held constant without change from the initial value, and only the development bias value is changed to adjust the contrast potential to a desired value.

In the continuous print job having a smaller number of pages, because a variation in the image concentration after printing is small, it is preferable that the continuous print job of the contrast potential to be adjusted is limited to only the print jobs of a given number of pages or more (for example, 500 pages).

Also, if the input job is other than the continuous print job, the image stabilization mode determination unit 206 compares the accumulative image formation frequency stored in the database unit 205 with the upper limit of the image formation frequency to finally determine whether the execution of the first image stabilization mode is necessary, or not.

The pattern image concentration detector 207 computes the image concentration of the pattern image formed on the intermediate transfer belt 15 at the time of executing the first image stabilization mode (pattern image concentration adjustment). Also, the pattern image concentration detector 207 receives, by the optical sensor 14b, the reflected light of the light with which the pattern image formed on the intermediate transfer belt 15 is irradiated from the LED light source 14a, and computes the pattern image concentration from a reflectivity thereof.

The pattern image concentration comparator 208 compares the pattern image concentration computed by the pattern image concentration detector 207 with a predetermined target concentration, and outputs a comparison result to the controller 202.

At the time of executing the second image stabilization mode, the target contrast potential determination unit 209 refers to the database unit 205 with the image formation frequency counted within the continuous print job and a parameter such as the print ratio as keys, and determines the target contrast potential corresponding to the image formation frequency. As described above, three tables that define the relationship between the target contrast potential and the image formation frequency (the number of prints) are provided within the database unit 205 as the first Vc adjustment table 205a, the second Vc adjustment table 205b, and the third Vc adjustment table 205c.

Methods of determining the target contrast potential by the target contrast potential determination unit 209 at the time of executing the second image stabilization mode are described below, and arbitrarily selectable.

(1) Referring to the first Vc adjustment table 205a with the print ratio of the print image pertaining to the continuous print job and the image formation frequency within the continuous print job as keys, the target contrast potential is determined.

(2) Referring to the second Vc adjustment table 205b with the interval time calculated from a final execution time of another print job included in the print job execution history and the present time, and the image formation frequency within the continuous print job as keys, the target contrast potential is determined.

(3) Referring to the third Vc adjustment table 205c with a value of humidity acquired from a temperature and humidity sensor, and the image formation frequency within the continuous print job as the keys, the target contrast potential is determined.

(4) The target contrast potentials acquired from the respective tables in the methods of (1) to (3) are combined together on the basis of a given rule to determine the final target contrast potential. For example, a mean value of the respective target contrast potentials acquired from the three tables may be used. Also, a priority order and the ratio are determined in the three parameters (print ratio, interval time, and humidity) in advance, and the final target contrast potential may be calculated from a given mathematical expression.

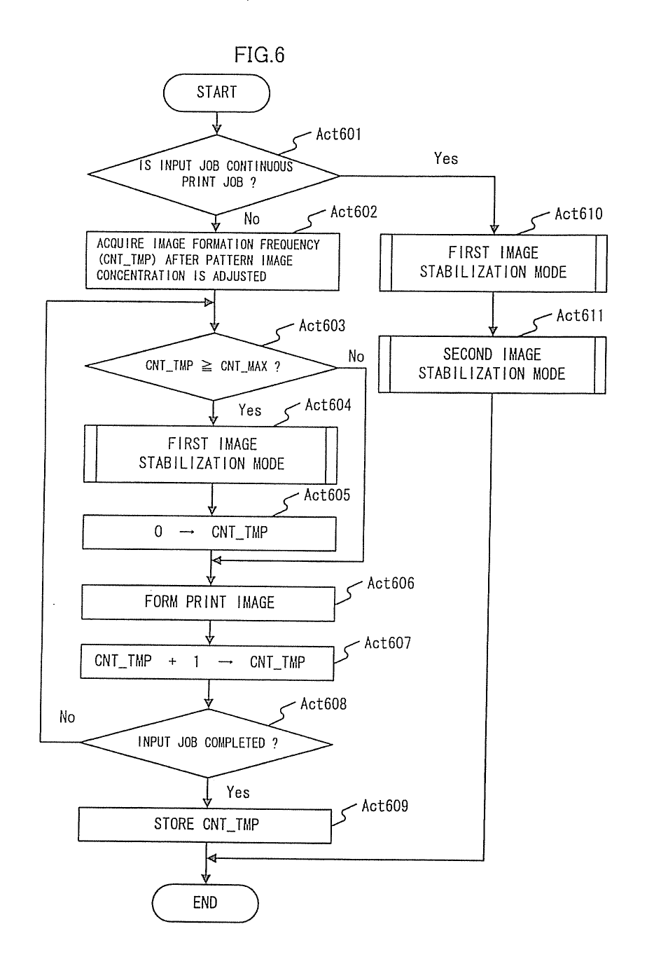

Subsequently, the control operation of the image forming apparatus 101 configured as described above will be described with reference to a flowchart shown in FIG. 6. In the present specification, “continuous print job” is directed to a job of printing the same image on a given number or more of sheets.

In Act 601, the image stabilization mode determination unit 206 analyzes the input job, and determines whether the input job is the continuous print job, or not. In this time, if the image stabilization mode determination unit 206 determines that the input job is the continuous print job, the processing is advanced to Act 610. On the contrary, if the image stabilization mode determination unit 206 determines that the input job is not the continuous print job, the processing is advanced to Act 602.

In Act 602, the image formation frequency counter 204 acquires the image formation frequency counted after the final execution of the first image stabilization mode (pattern image concentration adjustment) from the database unit 205, and stores the image formation frequency thus acquired in a variable CNT_TMP.

In Act 603, the image stabilization mode determination unit 206 compares the variable CNT_TMP with a variable CNT_MAX indicative of the upper limit of the image formation frequency, which is the execution condition of the first image stabilization mode, and outputs a determination result to the controller 202. If the image stabilization mode determination unit 206 determines that the CNT_TMP arrives at the CNT_MAX (yes in Act 603), the processing is advanced to Act 604. On the contrary, if the image stabilization mode determination unit 206 determines that the CNT_TMP is lower than the CNT_MAX (no in Act 603), the processing is advanced to Act 606.

In Act 604, the controller 202 executes the first image stabilization mode (pattern image concentration adjustment) for controlling the pattern image formation unit 203b, the pattern image concentration detector 207, and the pattern image concentration comparator 208, and initializes the CNT_TMP to 0 after execution (Act 605). A detailed processing example of the first image stabilization mode will be described later.

In Act 606, the print image formation unit 203a executes forming of the print image on the basis of a control instruction from the controller 202.

In Act 607, the image formation frequency counter 204 increments the CNT_TMP by +1.

In Act 608, the controller 202 determines whether the input job is completed, or not. In this situation, if the controller 202 determines that the input job is completed (yes in Act 608), the processing is advanced to Act 609. On the contrary, if the controller 202 determines that the input job is not yet completed (no in Act 608), the processing is returned to Act 603, and processing of Act 603 to Act 608 is repeated until the input job is completed.

In Act 609, the controller 202 updates the image formation frequency of the database unit 205 by the value of the CNT_TMP acquired from the image formation frequency counter 204, and then completes the processing.

In Act 610, the controller 202 executes the first image stabilization mode (pattern image concentration adjustment).

In Act 611, the controller 202 executes the second image stabilization mode for controlling the development bias in the developing device 13 on the basis of the target contrast potential determined by the target contrast potential determination unit 209, and completes the processing. A detailed processing example of the second image stabilization mode will be described later.

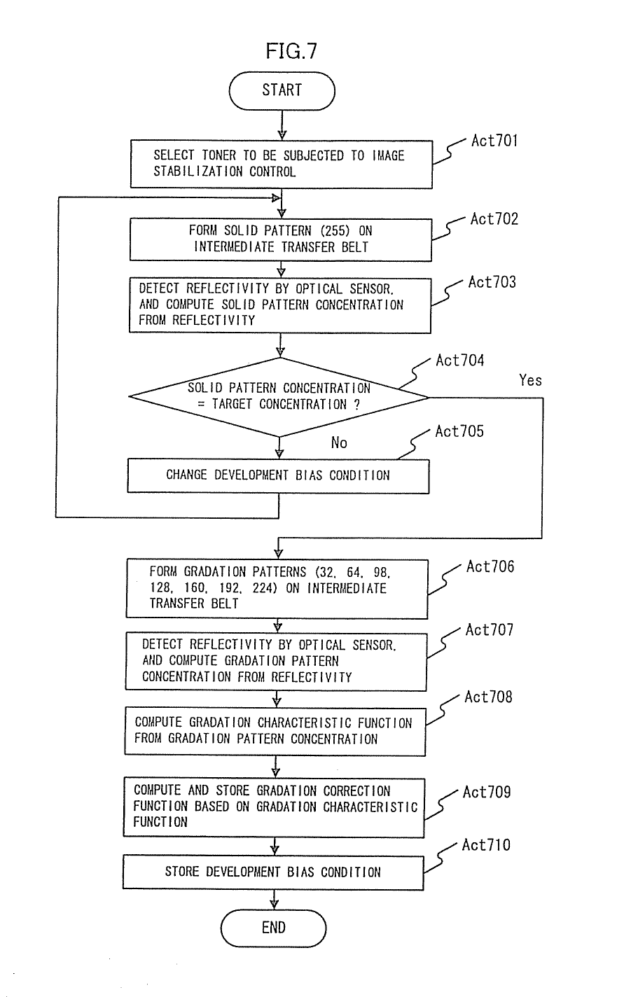

Subsequently, a detailed processing example of the first image stabilization mode shown in Act 604 of FIG. 6 will be described with reference to a flowchart of FIG. 7.

In Act 701, the controller 202 starts the execution of the first image stabilization mode on the basis of the determination result output by the image stabilization mode determination unit 206, and selects toner to be processed.

In Act 702, the controller 202 controls the pattern image formation unit 203b and the exposing unit 21, and forms a solid pattern image having a gradation concentration of 255/255 in a halftone dot screen of, for example, 160 lines, on the intermediate transfer belt 15. In more detail, the controller 202 first supplies the solid pattern image generated by the pattern image formation unit 203b to the exposing unit 21. The exposing unit 21 then forms latent images of the solid pattern image on the photosensitive drums 11a to 11d. With this operation, the developing devices 13a to 13d develop the latent images. The developed images are formed on the surfaces of the photosensitive drums 11a to 11d. Then, developed image is transferred onto the intermediate transfer belt 15.

In Act 703, the pattern image concentration detector 207 acquires the reflectivity of the solid pattern transferred to the intermediate transfer belt 15 from the optical sensor 14b, and computes the concentration of the solid pattern (hereinafter referred to as “solid pattern concentration”) from the reflectivity.

In Act 704, the pattern image concentration comparator 208 determines whether the solid pattern concentration arrives at a target concentration, or not. In this situation, if the pattern image concentration comparator 208 determines that the solid pattern concentration does not arrive at the target concentration (no in Act 704), the pattern image concentration comparator 208 detects an error from the predetermined target concentration to output the detected error to the controller 202. The controller 202 then changes the image formation condition on the basis of the output error (Act 705). The controller 202 then repeats the processing of Act 702 to Act 704 until the pattern image concentration comparator 208 determines that the solid pattern concentration matches the target concentration (yes in Act 704).

The change of the image formation condition to the target concentration in Act 705 can be realized by changing the development bias value applied between the developing devices 13a to 13d and the photosensitive drums 11a to 11d, and the charge potential charged to the photosensitive drums 11a to 11d by the static chargers 17a to 17d, while keeping the same potential difference, and changing the development contrast potential to adjust the solid pattern concentration, through the controller 202. In the method of adjusting the solid pattern concentration, the controller 202 may apply the correction amounts of the development bias value and the charge bias value, which is recorded as a table in the database unit 205 in advance according to the error between the image concentration of the solid pattern and the target concentration of the solid pattern concentration. The controller 202 corrects the development bias value and the charge bias value, and thereafter again prints the solid pattern or a high-concentration pattern to detect the solid pattern concentration. Upon reception of the detection result, the controller 202 again executes the same correction control.

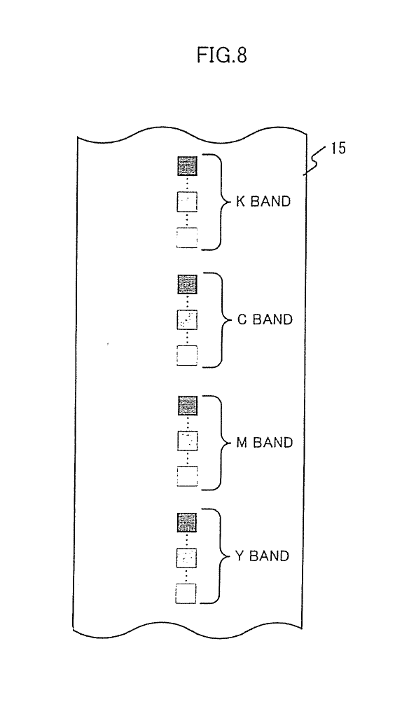

In Act 706, the controller 202 controls the image formation processor 203 so as to form the gradation pattern of halftone as the gradation screen pattern on the intermediate transfer belt 15 in a state where the solid pattern concentration becomes the target concentration value. The controller 202 reads, from the database unit 205, seven patterns (hereinafter referred to as “gradation patterns”) corresponding to the gradation levels of 32/255, 64/255, 96/255, 128/255, 160/255, 192/255, and 224/255 in the halftone dot screen of, for example, 160 lines, and forms the patterns on the intermediate transfer belt 15. FIG. 8 illustrates an example of the gradation pattern formed on the intermediate transfer belt 15 in a color stabilization state. In this example, a band of 16 gradation pattern patches of each of yellow (Y), magenta (M), cyan (C), and black (K) is formed on the intermediate transfer belt 15.

In Act 707, the pattern image concentration detector 207 detects the reflectivity of the gradation pattern for each gradation level by the optical sensor 14b, and obtains the gradation pattern concentration from the reflectivity detected by the optical sensor 14b.

In Act 708, the controller 202 obtains the gradation characteristic table or the gradation characteristic function of the halftone dot screen of 160 lines on the basis of the gradation pattern concentration computed by the pattern image concentration detector 207. A relationship of the gradation value between the reflectivity detected by the optical sensor 14b and the final image on the output medium may be stored in the database unit 205 in advance.

In Act 709, the controller 202 obtains a gradation correction table (or a gradation correction function) for correcting an error to a predetermined gradation from the gradation characteristic table (or the gradation characteristic function). Then, the controller 202 stores the gradation correction table (or the gradation correction function) obtained by computation in the database unit 205.

In Act 710, the controller 202 stores the final development bias condition and the other image formation condition in the database unit 205, and completes the processing. The value of the development bias is used as the reference value and the initial value of the development bias at the time of executing the second image stabilization mode that will be described later.

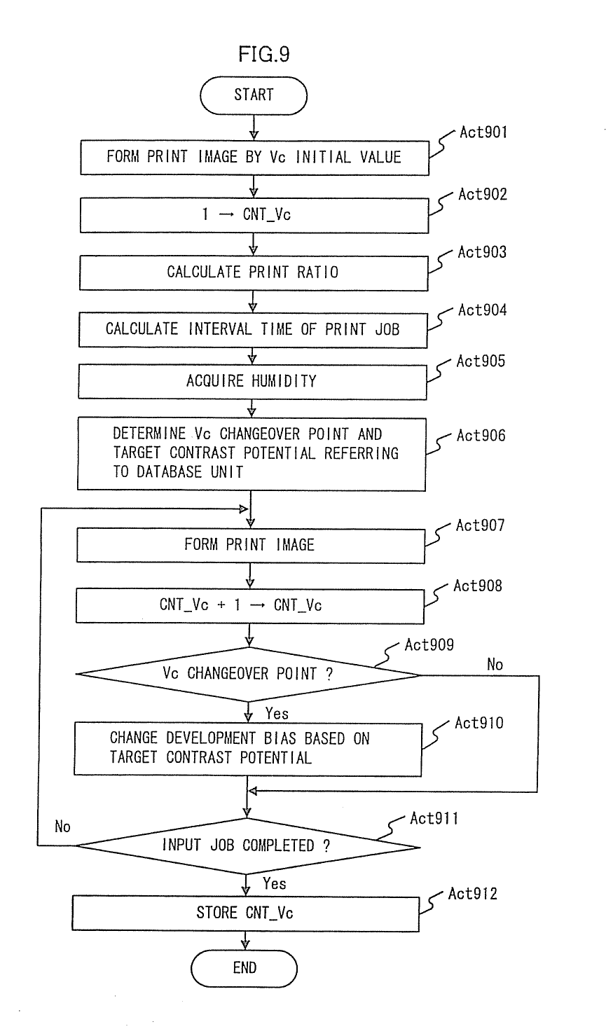

Finally, a detailed processing example of the second image stabilization mode shown in Act 611 of FIG. 6 will be described with reference to a flowchart of FIG. 9.

In Act 901, the controller 202 controls the print image formation unit 203a and the developing device 13, and forms the print image under the image formation condition at the time of completing the first image stabilization mode.

In Act 902, the image formation frequency counter 204 assigns 1 to the variable CNT_Vc representative of the image formation frequency within the same continuous print job.

In Act 903, the print image formation unit 203a calculates the print ratio of a first print image, and outputs the calculated print ratio to the target contrast potential determination unit 209.

In Act 904, the controller 202 calculates the interval time from the present time acquired from a system clock (not shown) and the final execution time included in the execution history stored in the print job execution history table 205d, and outputs the calculated interval time to the target contrast potential determination unit 209.

In Act 905, the controller 202 acquires humidity from the temperature and humidity sensor 80, and outputs the acquired humidity to the target contrast potential determination unit 209.

In Act 906, the target contrast potential determination unit 209 refers to the database unit 205 on the basis of the contents of the input job, and determines a Vc changeover point. For example, in the case of data shown in FIG. 5, in the continuous point job of 500 prints, 100 prints, 200 prints, 300 prints, and 400 prints become the respective Vc changeover points. Also, the target contrast potential determination unit 209 refers to the Vc adjustment tables 205a to 205c with the CNT_Vc, the print ratio, the interval time, and the humidity as the respective keys, determines the target contrast potential for each of the Vc changeover points, and outputs the determined target contrast potential to the controller 202.

Now, a description will be given of a method of determining the target contrast potential in an example where the print ratio is 10%, the interval time is 5 h, and the humidity is 40% at the time of inputting the continuous print job of 1000 prints.

First, referring to the database unit 205 illustrated in FIG. 5, the Vc changeover point can be determined at intervals of 100 prints. Accordingly, when the image formation of 200 prints is completed, and 201^{st} image formation is conducted, if the print ratio is 10%, 254 V can be acquired as the target contrast potential referring to the first Vc adjustment table 205a.

Also, if the interval time is 5 h, 251 V can be acquired as the target contrast potential referring to the second Vc adjustment table 205b.

Further, if the humidity is 40%, 251 V can be acquired as the target contrast potential referring to the third Vc adjustment table 205c.

Then, a mean value of the values (254 V, 251 V, and 251 V) acquired from the respective tables is calculated with the result that the final target contrast potential in the case of conducting the 201^{st} image formation can be determined to 252 V.

In Act 907, the controller 202 controls the print image formation unit 203a and the developing device 13 to form the print image.

In Act 908, the image formation frequency counter 204 increments the CNT_Vc by +1.

In Act 909, the target contrast potential determination unit 209 determines whether the CNT_Vc arrives at the Vc changeover point, or not. In this case, if the target contrast potential determination unit 209 determines that the CNT_Vc is the Vc changeover point (yes in Act 909), the processing is advanced to Act 910. On the contrary, if the target contrast potential determination unit 209 determines that the CNT_Vc is not the Vc changeover point (no in Act 909), the processing is advanced to Act 911.

In Act 910, the controller 202 adjusts only the development bias value within the image formation conditions so that the contrast potential becomes the target contrast potential determined by the target contrast potential determination unit 209.

In Act 911, the controller 202 determines whether the input job is completed, or not. In this situation, if the controller 202 determines that the input job is completed (yes in Act 911), the processing is advanced to Act 912. On the contrary, if the controller 202 determines that the input job is not completed (no in Act 911), the processing is returned to Act 907, and repeats the processing of Act 907 to Act 911 until the input job is completed.

In Act 912, the controller 202 stores the value of CNT_Vc counted by the image formation frequency counter 204 in the database unit 205, and completes the processing. In this embodiment, the first image stabilization mode is executed together before the execution of the second image stabilization mode, and completes the processing. Therefore, the value of the variable CNT_Vc is indicative of the image formation frequency counted after the final execution of the first image stabilization mode.

As described above, according to the image forming apparatus of this embodiment, even in the case of a job for continuously printing the same image in a large amount, only the development bias value is controlled during the execution of the same continuous print job so that the contrast potential can be finely adjusted at given print intervals. For that reason, a large difference in the image concentration between the first print image and the print image immediately before the job is completed can be prevented from occurring.

Also, even if the image formation frequency arrives at a given threshold value (the upper limit of the image formation frequency) during the execution of the continuous print job, because the second image stabilization mode is executed, it is unnecessary to interrupt the print job in order to execute the first image stabilization mode.

Also, because the target contrast potential can be determined on the basis of the conditions such as the print ratio, the interval time, or the humidity, the substantially constant image concentration can be kept even under various conditions.

While certain embodiments have been described these embodiments have been presented by way of example only, and are not intended to limit the scope of the inventions. Indeed, the novel apparatus and methods described herein may be embodied in a variety of other forms: furthermore various omissions, substitutions and changes in the form of the apparatus and methods described herein may be made without departing from the spirit of the inventions. The accompanying claims and their equivalents are intended to cover such forms of modifications as would fall within the scope and spirit of the invention.

What is claimed is:

1. An image forming apparatus, comprising:
an image formation unit that forms an image pertaining to a print job input from an external on an image carrier;
an image formation frequency count unit that counts an image formation frequency of the image in the image formation unit;
a first control unit that controls the image formation unit, and executes a first image stabilization mode for adjusting a development bias voltage on the basis of a concentration of a pattern image formed on the image carrier;
a target contrast potential determination unit that determines, when the print job is a continuous print job of the same image, a target contrast potential which is a target value of a potential difference between a potential of the image carrier after exposed and a potential of a developing device, according to the image formation frequency counted in the continuous print job; and
a second control unit that executes a second image stabilization mode for adjusting a development bias on the basis of the target contrast potential under execution of the continuous print job, with the development bias at the time of completing the first image stabilization mode which is executed by the first control unit as a reference value.

2. An image forming apparatus, comprising:
an image formation unit that forms an image pertaining to a print job input from an external on an image carrier;
an image formation frequency count unit that counts an image formation frequency of the image in the image formation unit;
a first control unit that controls the image formation unit, and executes a first image stabilization mode for adjusting a development bias voltage on the basis of a concentration of a pattern image formed on the image carrier;
a database unit that defines a relationship between a target contrast potential that is a target value of a potential difference between a potential of the image carrier after exposed and a potential of the developing device, and the image formation frequency within the print job in advance;
a target contrast potential determination unit that determines, when the print job is a continuous print job of the same image, the target contrast potential, referring the database unit with the image formation frequency within the continuous print job as a key; and
a second control unit that executes a second image stabilization mode for adjusting a development bias on the basis of the target contrast potential under execution of the continuous print job, with the development bias at the time of completing the first image stabilization mode which is executed by the first control unit as a reference value.

3. The apparatus according to claim 2, further comprising:
an image stabilization mode determination unit that analyzes the print job, determines whether the print job is under execution of the first image stabilization mode, or not, on the basis of the image formation frequency when the print job is other than the continuous print job of the same image, and determines that the print job is under execution of the second image stabilization mode when the print job is the continuous print job of the same image,
wherein the first and second control units execute the first and second image stabilization modes, respectively, on the basis of the determination result of the image stabilization mode determination unit.

4. The apparatus according to claim 3,
wherein the image stabilization mode determination unit does not determine the execution of the first image stabilization mode even if the image formation frequency exceeds the given threshold value, under execution of the continuous print job.

5. The apparatus according to claim 4,
wherein when the second control unit executes the second image stabilization mode, the first control unit executes and completes the first image stabilization mode together before starting the execution of the second image stabilization mode.

6. The apparatus according to claim 5,
wherein the database unit stores a relationship among the image formation frequency within the same continuous print job, the target contrast potential, and a print ratio of a print image therein, and
wherein the target contrast potential determination unit determines the target contrast potential, referring to the database unit with the print ratio of the print image pertaining to the continuous print job and the image formation frequency within the continuous print job as the keys, at the time of executing the second image stabilization mode.

7. The apparatus according to claim 5,
wherein the database unit stores a relationship among the image formation frequency within the same continuous print job, the target contrast potential, and an interval time from a final execution time of another print job, and an execution history of the another print job therein, and
wherein the target contrast potential determination unit determines the target contrast potential, referring to the database unit with the interval time calculated from the present time and the execution history and the image formation frequency within the continuous print job as the keys, at the time of executing the second image stabilization mode.

8. The apparatus according to claim 5,
wherein the database unit stores a relationship among the image formation frequency within the same continuous print job, the target contrast potential, and a humidity within the apparatus therein, and
wherein the target contrast potential determination unit determines the target contrast potential, referring to the database unit with a value of the humidity acquired from a temperature and humidity sensor and the image formation frequency within the continuous print job as the keys, at the time of executing the second image stabilization mode.

9. The apparatus according to claim 5,
wherein the database unit includes:
a print job execution history table that stores a execution history of the print job therein;
a first Vc adjustment table that stores a relationship among the image formation frequency within the same continuous print job, the target contrast potential, and a print ratio of a print image therein;
a second Vc adjustment table that stores a relationship among the image formation frequency within the same continuous print job, the target contrast potential, and an interval time from a final execution time of another print job therein; and
a third Vc adjustment table that stores a relationship among the image formation frequency within the same continuous print job, the target contrast potential, and a humidity within the apparatus therein, and
wherein the target contrast potential determination unit acquires the target contrast potentials from the respective tables of the database unit with the combination of the print ratio of the print image pertaining to the continuous print job, the interval time calculated from the present time and the execution history, or a value of the humidity acquired from a temperature and humidity sensor and the image formation frequency as the keys, at the time of executing the second image stabilization mode and determines the final target contrast potential according to a mean value of the acquired target contrast potentials.

10. The apparatus according to claim 9,
wherein the image stabilization mode determination unit analyzes the print job, and does not determine the execution of the second image stabilization mode when the print job is a continuous print job of the same image whose print number is smaller than a given number.

11. The apparatus according to claim 10, further comprising:
a pattern image concentration detector that detects a concentration of the pattern image formed on the image carrier at the time of executing the first image stabilization mode; and
a pattern image concentration comparator that compares the concentration of the pattern image detected by the pattern image concentration detector with a target concentration defined in advance, and outputs a comparison result to the first control unit.

12. An image stabilization control method in an image forming apparatus, comprising:
counting an image formation frequency of an image by the image forming apparatus that forms the image pertaining to a print job input from an external on an image carrier;
executing a first image stabilization mode for adjusting a development bias voltage on the basis of a concentration of a pattern image formed on the image carrier;
determining a target contrast potential, when an analysis result of the print job is a continuous print job of the same image referring to a database that defines, in advance, a relationship between a target contrast potential that is a target value of a potential difference between a potential of the image carrier after exposed and a potential of a developing device, and an image formation frequency within the continuous print job with the image formation frequency within the continuous print job as a key; and
executing a second image stabilization mode for adjusting a development bias during execution of the continuous print job on the basis of the target contrast potential with the development bias at the time of executing the first image stabilization mode as a reference value.

13. The method according to claim 12,
wherein the execution determination of the first image stabilization mode is not conducted even if the image formation frequency exceeds a given threshold value during execution of the continuous print job.

14. The method according to claim 13,
wherein when the second image stabilization mode is executed, the first image stabilization mode is executed and completed before the second image stabilization mode starts.

15. The method according to claim 14,
wherein a relationship among the image formation frequency within the continuous print job, the target contrast potential, and a print ratio of a print image is defined within the database in advance, and
wherein the target contrast potential is determined referring to the database with the print ratio of the print image pertaining to the continuous print job and the image formation frequency within the continuous print job as the keys, at the time of executing the second image stabilization mode.

16. The method according to claim 14,
wherein a relationship among the image formation frequency within the continuous print job, the target contrast potential, and an interval time from a final execution time of another print job, and an execution history of the another print job are defined within the database in advance, and
wherein the target contrast potential is determined referring to the database with the interval time calculated from the present time and the execution history and the image formation frequency within the continuous print job as the keys, at the time of executing the second image stabilization mode.

17. The method according to claim 14,
wherein a relationship among the image formation frequency within the continuous print job, the target contrast potential, and a humidity within the apparatus is defined within the database in advance, and
wherein the target contrast potential is determined referring to the database with a value of the humidity acquired from a temperature and humidity sensor and the image formation frequency within the continuous print job as the keys, at the time of executing the second image stabilization mode.

18. The method according to claim 14,
wherein the database includes:
a print job execution history table that stores the execution history of the print job therein;
a first Vc adjustment table that stores a relationship among the image formation frequency within the continuous print job, the target contrast potential, and a print ratio of a print image therein;
a second Vc adjustment table that stores a relationship among the image formation frequency within the continuous print job, the target contrast potential, and an interval time from a final execution time of another print job therein; and
a third Vc adjustment table that stores a relationship among the image formation frequency within the continuous print job, the target contrast potential, and a humidity within the apparatus therein, and
wherein the target contrast potentials are acquired from the respective tables provided in the database with the combination of the print ratio of the print image pertaining to the continuous print job, the interval time calculated from the present time and the execution history, or a value of the humidity acquired from a temperature and humidity sensor and the image formation frequency as the keys, at the time of executing the second image stabilization mode to determine the final target contrast potential according to a mean value of the acquired target contrast potentials.

19. The method according to claim 18,
wherein when an analysis result of the print job is a continuous print job of the same image whose print number is smaller than a given number, the execution determination of the second image stabilization mode is not conducted.

20. The method according to claim 19, further comprising:
detecting a concentration of the pattern image formed on the image carrier at the time of executing the first image stabilization mode;
comparing the detected concentration of the pattern image with a target concentration defined in advance; and
adjusting an image formation condition of the pattern image until a comparison result is that the detected concentration matches the target concentration.
